(19) United States
(12) Patent Application Publication
(10) Pub. No.: US 2014/0164830 A1
(43) Pub. Date: Jun. 12, 2014

(54) USING A VIRTUAL BOOT DEVICE TO ACCESS A SYSTEM RECOVERY IMAGE

(71) Applicants: Alastair M. Slater, Chepstow Monmouthshire (GB); Benjamin L. Simpson, Bristol (GB); Andrew J. Todd, Bristol (GB)

(72) Inventors: Alastair M. Slater, Chepstow Monmouthshire (GB); Benjamin L. Simpson, Bristol (GB); Andrew J. Todd, Bristol (GB)

(21) Appl. No.: 14/233,742

(22) PCT Filed: Oct. 14, 2011
(86) PCT No.: PCT/US2011/056328

§ 371 Date: Jan. 18, 2014

(51) Int. Cl. G06F 11/14; G06F 9/44; G06F 9/455

(52) U.S. Cl. CPC G06F 11/1417; G06F 9/455; G06F 9/4401
USPC 714/15

(57) ABSTRACT

A technique that includes presenting a virtual cartridge including a system recovery image to a computer system. The technique includes using a virtual boot device to access the system recovery image.

### BACKGROUND

A typical computer network may have a backup and recovery system for purposes of restoring data (one or multiple files, for example) on the network to a prior state should the data become corrupted, be overwritten, subject to an attack from a virus, etc. Traditionally, the backup and recovery system may include physical magnetic tape drives that store backup data on magnetic tapes. After a transfer of backup data to a given magnetic tape, the tape may be removed from its tape drive and stored in a secure location, such as in a fireproof safe. The backup and recovery system may alternatively be a virtual tape library-based system that emulates but replaces the physical magnetic tape drive system. With a virtual tape library-based system, virtual cartridges, instead of magnetic tapes, store the backup data.

### BRIEF DESCRIPTION OF THE DRAWING

FIG. 1 is a schematic diagram of a computer system and a storage appliance according to an example implementation.

FIGS. 2, 4 and 5 are flow diagrams depicting techniques to use a virtual boot device to access a system recovery image according to example implementations.

FIG. 3 is an illustration of a system recovery image according to an example implementation.

FIG. 6 is an illustration of a graphical user interface (GUI) according to an example implementation.

### DETAILED DESCRIPTION

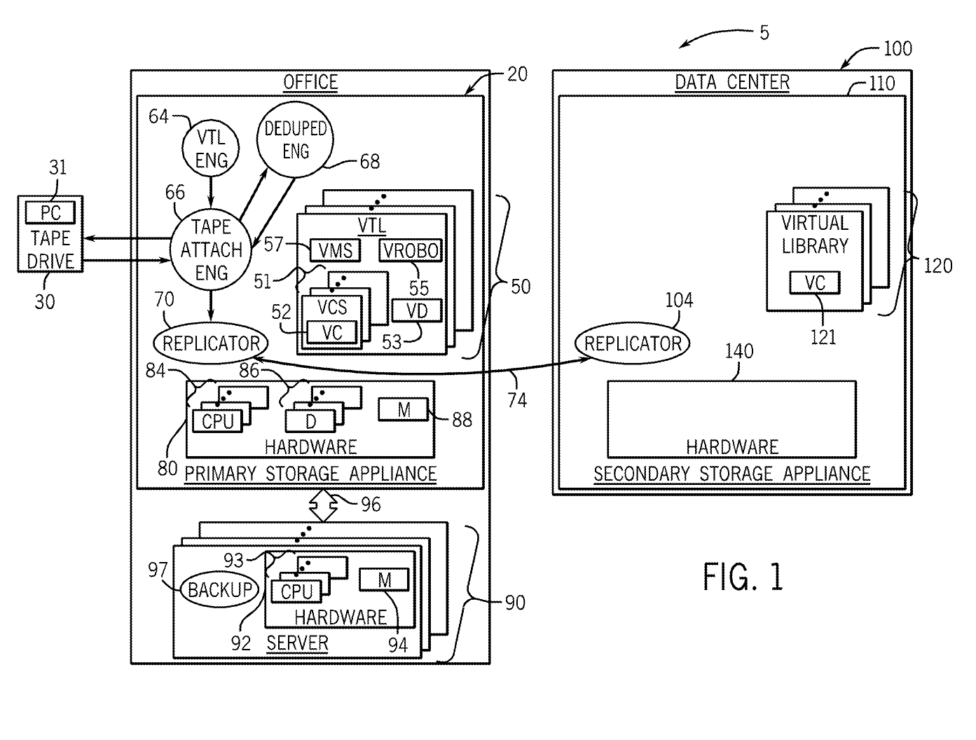

Referring to FIG. 1, an example computer network 100 includes a computer system 180 (an application server, storage server, web server, etc.) and a virtual tape library storage appliance (herein called the “storage appliance 108”). In general, the computer system 180 uses the storage appliance 108 for purposes of backing up and restoring the computer system's data. In this regard, in accordance with some implementations, the computer system 180 may execute machine executable instructions to form (as non-limiting examples) a backup application 182 to store backup data on the storage appliance 108 and a recovery application 184 to restore data on the computer system 180 using backup data stored on the storage appliance 108 should the need arise. In some implementations, a single backup/recovery application may replace the backup 182 and recovery 184 applications.

In accordance with some implementations, the storage appliance 108 and the computer system 180 are “physical machines,” or actual machines that are made up of software and hardware. Although each of the storage appliance 108 and the computer system 180 is depicted in FIG. 1 as being contained within a box, a particular physical machine may be a distributed machine, which has multiple nodes that provide a distributed and parallel processing system. Thus, the storage appliance 108 and the computer system 180 may be located within one cabinet (or rack); or alternatively, the storage appliance 108 and the computer system 180 may be located in multiple cabinets (or racks).

In general, the computer system 180 may include hardware 190, such as one or multiple Central Processing Units (CPUs) 192 and a memory 193 that stores machine executable instructions, application data, and so forth. In general, the memory 193 is a non-transitory memory, which may include semiconductor storage devices, magnetic storage devices, optical storage devices, and so forth.

In addition to the machine executable instructions that form the backup application 182 and the recovery application 184, the computer system 180 may include other sets of machine executable instructions that when executed by the CPU(s) 192 form an operating system for the computer system 180, a graphical user interface (GUI) 188 for interacting with the storage appliance 108, device drivers, and so forth.

The computer system 180 communicates with the storage appliance 108 over a communication link 176, which may include one or multiple buses or other fast interconnects. In this manner, the computer system 180 may communicate with the storage appliance 108 using one or multiple protocols, such as a serial attach Small Computer System Interface (SCSI) bus protocol, a parallel SCSI protocol, a Universal Serial Bus (USB) protocol, a Fibre Channel protocol, an Ethernet protocol, and so forth. Being a physical machine, the storage appliance 108 contains hardware 150, such as one or more CPUs 154; a non-transitory memory 156 that stores machines executable instructions, application data, and so forth; and one or multiple physical drives 155 (optical drives, solid state drives, magnetic storage drives, etc) that store, among other data content, the backup data for the computer system 180.

The storage appliance 108, in general, emulates a physical tape drive system and as such, presents a virtual tape drive system interface to the computer system 180. The virtual tape drive system interface has virtual components that correspond to components of a physical tape drive system. In general, the storage appliance 108 provides one or multiple selectable ports (V-Ethernet, V-Fibre Channel, and so forth) through corresponding interfaces 170 for purposes of presenting virtual entities to the computer system 180. As a more specific example, the storage appliance 108 presents one or multiple virtual tape libraries, called “virtual libraries 120” herein. Example virtual libraries 120₁, 120_{P} and 120_{N} are depicted in FIG. 1. Although the computer system 180 perceives the backup/restore operations as using physical tapes, the “tapes” are “virtual tapes,” or “virtual cartridges,” which are stored on the physical drives 155 of the storage appliance 108, instead of being stored on tape media.

Each virtual library 120 has virtual tape cartridge slots (called, “virtual cartridge slots 130” herein), with each virtual cartridge slot 130 being associated with a unit of data called a “virtual cartridge” (i.e., an emulated physical tape cartridge). The storage appliance 108 assigns a unique identifier, or “barcode,” to each virtual cartridge when created, and this barcode is used to track the virtual cartridge. In addition to its virtual cartridge slots 130, the virtual library 120 includes other virtual components, such as one or multiple virtual tape drives 124 used to effect data transfer/restoral; virtual robotics 126 used to move media between the virtual cartridge slots 130 and the virtual drives 124; and a virtual mail slot 122, which is used to transfer the virtual cartridges in and out of the virtual library 120.

As depicted in FIG. 1, the storage appliance 108 includes a set of machine executable instructions that when executed by the hardware 150 of the storage appliance 108 form an instance of a virtual tape library engine 160, which, in general, communicates with the backup 182 and recovery 184 applications to allow the applications 182 and 184 to interact with the virtual components (the virtual drive, the virtual robotics, the virtual mail slot, and so forth) of the storage appliance 108 for purposes of controlling movement of the virtual cartridges, and the reading and writing of the virtual cartridges.

In accordance with example implementations disclosed herein, the virtual library 120 has a selectable emulation class, or mode, which allows a given virtual library 120 to be configured to emulate not only a physical tape drive library (as described above) but also allows the virtual library 120 to be configured so that a virtual drive 124 of the virtual library 120 may be used as a boot device for the computer system 180. More specifically, in accordance with some example implementations, a virtual library 120 may be selectably configured to operate in a Compact Disc Read-Only-Memory (CD) drive emulation class, or mode, so that its virtual components (the virtual drive 124, robotics 126, and so forth) are configured accordingly to appear (to the computer system 180) to be the corresponding physical components of a library that employs a CD-ROM drive.

In this manner, the computer system 180 may not have a native ability (e.g., an ability imparted by its firmware) to boot up from a tape drive (either virtual or physical). However, the computer system 180 is able to boot up from an emulated boot up device, such as an emulated CD-ROM drive, as a non-limiting example.

For normal backup and restoration operations, the virtual libraries 120 are configured to be virtual tape libraries, and as such, the applications 180 and 184 perceive the libraries 120 to employ physical tape drives. Therefore, the applications 180 and 184 move the virtual cartridges and read and write to the virtual cartridges by interacting with the virtual tape drive components of these virtual libraries 120. However, a given virtual library 120 may be configured to be in a CD-ROM drive emulation mode, which allows the computer system 180 to boot up from a virtual drive 124 (now emulated a CD-ROM drive) of that virtual library 120.

Remotely booting up from an emulated CD-ROM of the storage appliance 108 may occur in connection with a disaster recovery operation (herein called a “recovery operation”) for the computer system 180 in which software, data, and/or hardware components of the computer system 180 fail, become corrupted, or otherwise cannot be adequately used. In the recovery operation, the computer system 180 boots up from a boot up device-configured virtual drive 124 of the storage appliance 108 and as described further below in example implementations, restores its operation environment as well as recovers data stored on the storage appliance 108.

More specifically, as depicted in FIG. 1, example virtual libraries 120₁ and 120_{N} are configured to emulate libraries that employ physical tape devices, as graphically depicted by the “T” (for tape) reference for the drives 124₁ and 124_{N} and the robotics 126₁ and 126_{N}. Unlike example virtual libraries 120₁ and 120_{N}, example virtual library 120_{P} is configured to emulate a library that employs the use of a CD-ROM drive: a virtual drive 124_{P} of the virtual library 120_{P} emulates a CD-ROM drive and virtual robotics 126_{P} of the virtual library 120_{P} emulates robotics associated with the CD-ROM drive, as indicated by the “BD” (for boot device) reference. The computer system 180 may be configured to boot up from the virtual drive 124_{P} in a recovery operation. More specifically, the computer system 180 may use the virtual drive 124_{P} to access a particular virtual cartridge 162 (stored in example slot 130a) of the library 120_{P}, which contains a system recovery image 134.

In accordance with some implementations, the system recovery image 134 includes an operating system (OS) boot image and other data to aid in the recovery operation and further facilitate the recovery of backup data from the storage appliance 108: machine executable instructions to restore the recovery application 184, configuration settings, machine executable instructions to restore one or multiple device drives, backup data, and so forth. In accordance with some implementations, the system recovery image 134 may be a One Button Disaster Recovery (OBDR) image, which may be created by the recovery application 184 and stored on the storage appliance 108 in the virtual cartridge 162.

The initiation of a recovery operation may occur in several different ways, depending on the implementation. For example, in accordance with some implementations, the computer system 180 may boot-up from the virtual drive 124_{P} and begin the recovery operation in response to a user pressing a physical button of the storage appliance 108 or a physical button of the computer system 180. As another example, in accordance with other implementations, the computer system 180 may boot-up from the virtual drive 124_{P} and begin the recovery operation in response to a user selecting a software icon that is displayed on a monitor of the computer system 180. In yet other implementations, the computer system 180 may automatically determine when to begin the recovery operation. Thus many variations are contemplated and are within the scope of the appended claims.

The boot-up of the computer system 180 from the virtual drive 124_{P} may proceed as follows. First, the computer system 180 shuts down, or powers off, and then the computer system 180 once again powers up. Upon powering up, the computer system 180 searches the network 100 for boot-up devices and upon discovering the virtual drive 124_{P}, boots up from the virtual drive 124_{P}. In some implementations, the recovery operation may involve the computer system 180 booting up and powering down more than one time. In some implementations, a boot up configuration setting that is stored on the network 100 may indicate a preference to boot up from the virtual drive 124_{P}.

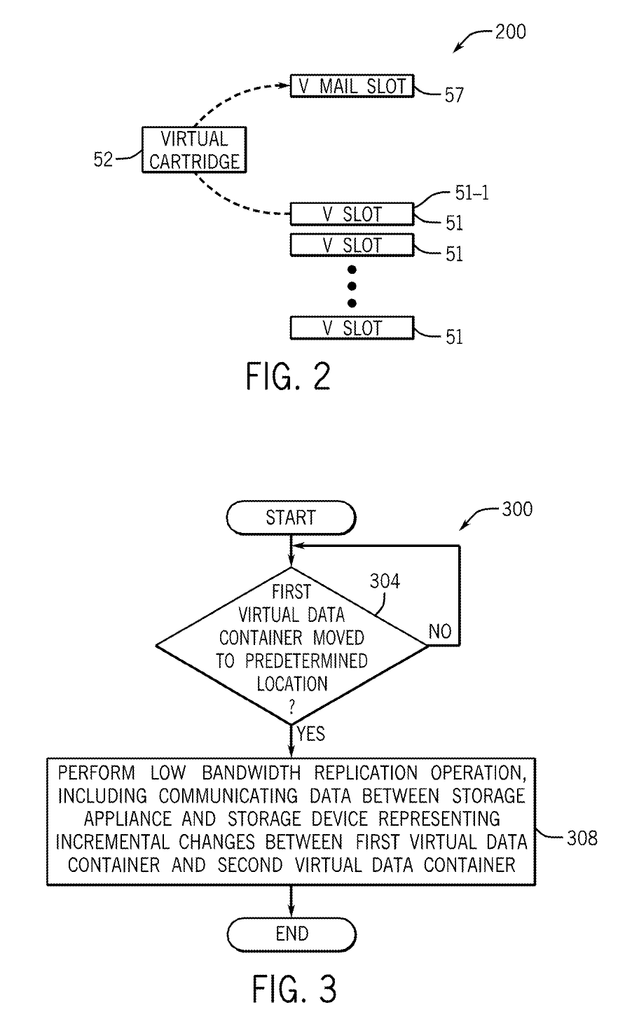

Thus, referring to FIG. 2 in conjunction with FIG. 1, a technique 200 in accordance with example implementations, includes providing (block 204) a virtual cartridge that contains a system recovery image and using (block 208) a virtual boot device to access the system recovery image to boot up a computer system to restore the computer system to a previous state.

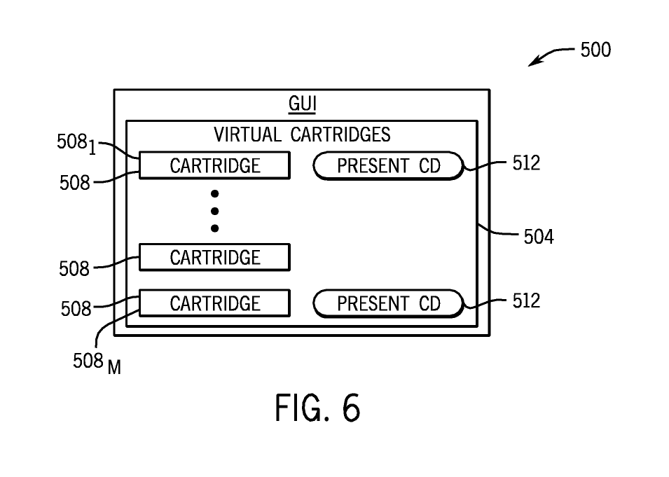

Referring back to FIG. 1, in accordance with some implementations, the recovery application 184 may perform such actions as changing an emulation class, or mode, of a given virtual library 120 of the storage appliance 108 to a CD-ROM drive emulation mode; change the emulation mode of a given virtual library 120 from a CD-ROM drive emulation mode to a tape drive emulation mode after the conclusion of a recovery operation; create the system recovery image 134; restore data on the computer system 180 during the recovery operation; control a configuration setting stored on the network 100 to identify the virtual drive 124 as the boot-up device; control a configuration setting stored on the network 100 to identify the cartridge to be loaded into the virtual drive 124 for the boot-up; and so forth. Moreover, the recovery application 184, in accordance with some implementations, provides the graphical user interface (GUI) 188, which allows a user of the computer system 180 to select which virtual cartridges stored on the storage appliance 108 may be used for purposes of booting up the computer system 180, as further described below in connection with FIG. 6.

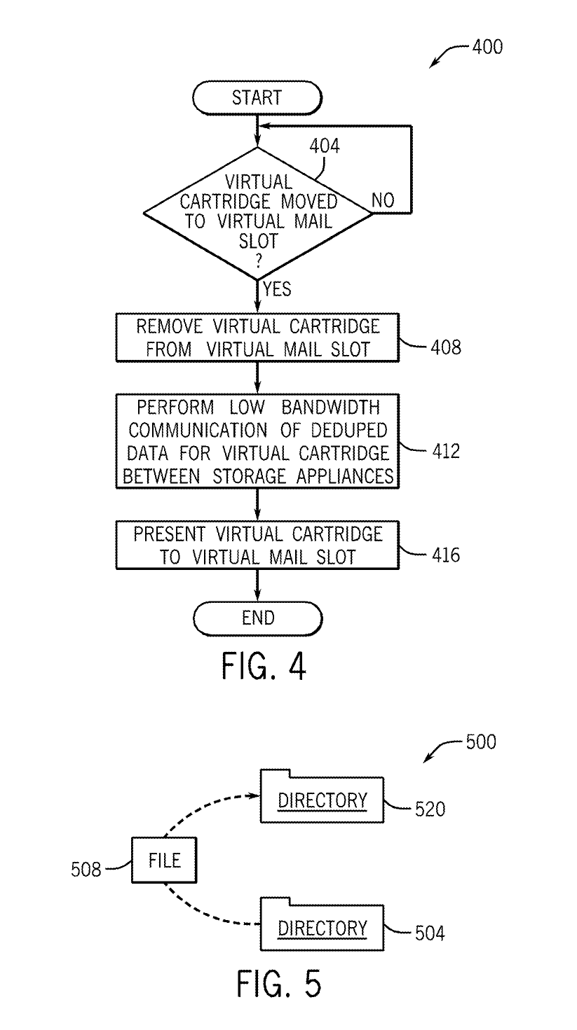

Referring to FIG. 3, in accordance with an example implementation, the system recovery image 134 may include an image header 304, which identifies the image 134 and an operating system boot image 308, which is constructed to load an operating system into the computer system 180 and boot up the computer system 180 to restore the basic operating system environment of the computer system 180. The system recovery image 134 may contain other data 312, such as data to restore the recovery application 184, data indicative of configuration settings, data to restore device drivers, and so forth.

Referring to FIG. 4, a technique 400 may be used in accordance with some implementations for purposes of identifying possible virtual cartridges containing the system recovery image 134 and configuring virtual drives to boot up the computer system 180 using these virtual cartridges. Pursuant to the technique 400, a determination is made (decision block 404) whether a detected virtual cartridge contains the system recovery image 134. In this regard, the virtual tape library engine 160 of the storage appliance 108 may, in accordance with some implementations, automatically detect via the image header 304 whether a given virtual cartridge stored on the storage appliance 108 contains a system recovery image 134. For example, the virtual tape library engine 160 may scan all newly created or newly updated virtual cartridges for the presence of the image header 304.

Upon detecting a virtual cartridge that contains a system recovery image 134, the virtual tape library 160 may notify the recovery application 184 to allow a user to make a determination (decision block 408) whether this virtual cartridge is to be used in a future restoration/recovery operation. This notification may be in response to a SCSI READ ELEMENT STATUS command that is generated by the computer system 180. Therefore, in some example implementations, the designation of the virtual cartridge that is used for boot-up (as well as the corresponding virtual library) is made via user input at the computer system 180. In other implementations, the computer system 180 may automatically select a virtual cartridge to be used for boot-up. Thus, many variations are contemplated and are within the scope of the appended claims.

After a determination has been made to identify the virtual cartridge as the boot-up cartridge (decision block 404), the technique 400 includes determining (decision block 412) whether a virtual library associated with the selected virtual cartridge is in a CD-ROM drive or a tape drive emulation mode. If the virtual library is in the tape drive emulation mode, then, pursuant to block 416, the recovery engine 184 changes the emulation mode of the virtual library to a CD-ROM drive emulation mode. As a non-limiting example, the recovery application 184 may effect this change by communicating a small computer system interface (SCSI) MODE SELECT command to the storage appliance 108 to change the emulation mode of the virtual library.

FIG. 5 depicts an example recovery technique 419 using the selected virtual cartridge and its associated virtual drive. The technique includes restoring the operating system environment and recovery/restoration application by booting up from the virtual drive (block 420), and then recovering the remaining back up data by the execution of the recovery application 484, pursuant to block 424. Finally, accordance to the technique 419, the emulation mode of the virtual drive is changed back to the tape drive emulation mode, pursuant to block 428, in accordance with a non-limiting example.

Referring to FIG. 6, in accordance with an example implementation, the GUI 188 of the computer system 180 may present a window 504, which contains the statuses of various virtual cartridges 508, which may be associated with one or multiple virtual tape libraries 120. As illustrated by way of example, the virtual cartridges 508₁ and 508₄ are identified by the GUI 188 as containing system recovery images 134. Therefore, for this example, the GUI 188 presents corresponding selectors 512 for the cartridges 508₁ for purposes of allowing a user of the computer system 180 to select the cartridge to be used for a future recovery/restoration operation. In accordance with some implementations, upon a user selecting a given virtual cartridge, the recovery application 184 ensures that a virtual drive of the same virtual library is configured to emulate a boot-up device (such as a CD-ROM drive), loads the selected virtual cartridge into the virtual drive, and controls a network configuration setting to ensure that the computer system 180 will boot up from the virtual drive.

Other implementations are contemplated and are within the scope of the appended claims. For example, one or multiple virtual drives may default to being bootable devices, such as CD-ROM devices, in accordance with other implementations. In some implementations, whether configured to emulate a boot device by default or not, the emulation mode of the virtual drive may be changed under certain circumstances. For example, if a certain number of SCSI bus resets occur, a given virtual tape library may be changed from a CD-ROM emulation mode to the tape drive emulation mode. Other variations are contemplated and are within the scope of the appended claims.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
presenting a virtual cartridge comprising a system recovery image to a computer system; and
using a virtual boot device to access the system recovery image to boot up the computer system.

2. The method of claim 1, wherein the virtual cartridge is stored in a virtual library comprising a virtual drive, the method further comprising configuring the virtual drive to be the virtual boot device.

3. The method of claim 1, wherein the act of configuring the virtual drive to be the virtual boot device comprises changing an emulation mode of the virtual drive from a tape drive emulation mode to a CD-ROM drive emulation mode.

4. The method of claim 3, wherein the act of changing comprises communication a mode select command.

5. The method of claim 3, further comprising:
changing the emulation mode of the virtual drive from the CD-ROM emulation mode to the tape emulation mode in response to the computer system being restored to the previous state.

6. The method of claim 1, wherein the using further comprises restoring the computer system to a previous state using the system recovery environment.

7. The method of claim 1, further comprising providing a graphical user interface to present the virtual cartridge and allow user selection of the virtual cartridge to provide the system recovery image.

8. An article comprising a processor readable storage medium to store instructions that when executed by a processor-based system cause the processor-based system to:
present a virtual cartridge comprising a system recovery image to a computer system; and
use a virtual boot device to access the system recovery image to restore the computer system to a previous state.

9. A system comprising:
an interface to present a virtual cartridge comprising a system recovery image to a computer system; and
an engine comprising a processor to use a virtual boot device to access the system recovery image to boot up the computer system.

10. The system of claim 9, wherein the engine is adapted to remotely access a virtual tape appliance to access the system recovery image.

11. The system of claim 9, wherein the virtual cartridge is stored in a virtual library comprising a virtual drive, the virtual library is maintained by a virtual appliance, and the engine is adapted to communicate with the virtual appliance to configure the virtual drive to be the virtual boot device.

12. The system of claim 11, wherein the engine is adapted to transmit a mode select command to the virtual appliance to change an emulation mode of the virtual drive.

13. The system of claim 9, wherein the virtual boot device comprises a virtual CD-ROM drive.

14. The system of claim 11, wherein the virtual tape cartridge is stored in a virtual library comprising a virtual drive, the virtual library is maintained by a virtual appliance, and the engine is adapted to, in response to the system being restored, communicate with the virtual appliance to change an emulation mode for the virtual drive from a first emulation mode associated with the virtual boot device to a second emulation mode associated with a tape drive.

15. The system of claim 11, wherein the system recovery image comprises an operating system image and a recovery application image.
